(19) United States
(12) Patent Application Publication
(10) Pub. No.: US 2020/0285992 A1
(43) Pub. Date: Sep. 10, 2020

(54) MACHINE LEARNING MODEL COMPRESSION SYSTEM, MACHINE LEARNING MODEL COMPRESSION METHOD, AND COMPUTER PROGRAM PRODUCT

(71) Applicant: KABUSHIKI KAISHA TOSHIBA, Minato-ku (JP)

(72) Inventors: Takahiro TANAKA, Akishima (JP); Atsushi YAGUCHI, Taito (JP); Ryuji SAKAI, Hanno (JP); Masahiro OZAWA, Yokohama (JP); Kosuke HARUKI, Tachikawa (JP)

(73) Assignee: KABUSHIKI KAISHA TOSHIBA, Minato-ku (JP)

(21) Appl. No.: 16/551,797

(22) Filed: Aug. 27, 2019

(30) Foreign Application Priority Data
Mar. 4, 2019 (JP) 2019-039023

(51) Int. Cl. G06N 20/00; G06F 17/16

(52) U.S. Cl. CPC G06N 20/00; G06F 17/16

(57) ABSTRACT

According to an embodiment, a machine learning model compression system includes a memory and a hardware processor. The hardware processor is coupled to the memory and configured to: analyze an eigenvalue of each layer of a machine learning model by using a data set and the machine learning model, the machine learning model having been learned based on the data set; determine a search range of a compressed model based on a count of eigenvalues, each of which is used for calculating a first value and causes the first value to exceed a predetermined threshold; select a parameter for determining a structure of the compressed model included in the search range; generate the compressed model by using the parameter, and judge whether the compressed model satisfies one or more predetermined restriction conditions or not.

### CROSS-REFERENCE TO RELATED APPLICATIONS

This application is based upon and claims the benefit of priority from Japanese Patent Application No. 2019-039023, filed on Mar. 4, 2019, the entire contents of which are incorporated herein by reference.

### FIELD

Embodiments described herein relate generally to a machine learning model compression system, a machine learning model compression method, and a computer program product.

### BACKGROUND

Application of machine learning, in particular deep learning, is advancing in various fields such as autonomous driving, manufacturing process monitoring and disease prediction. Above all, a machine learning model compression technique is gaining attention. For example, it is indispensable for autonomous driving to perform a real-time operation in an edge device having low arithmetic operation performance and a little memory resource like an in-vehicle image recognition processor. Thus, such an edge device requires a small-scale model. Hence, there is required a technique capable of compressing a model while satisfying a restriction for an operation in the edge device, and capable of maintaining recognition accuracy of a learned model as much as possible.

However, in conventional techniques, it is difficult to efficiently compress a machine learning model under predetermined restriction conditions.

### BRIEF DESCRIPTION OF THE DRAWINGS

FIG. 1 is a diagram illustrating an example of a functional structure of a machine learning model compression system according to a first embodiment;

FIG. 2 is a flowchart illustrating an example of a machine learning model compression method according to the first embodiment;

FIG. 3 is a diagram illustrating an example of a functional structure of a search unit according to the first embodiment;

FIG. 4 is a flowchart illustrating a detailed flow of step S204 according to first and second embodiments;

FIG. 5 is a diagram illustrating an example of a functional structure of a search unit according to the second embodiment;

FIG. 6 is a diagram illustrating an example of a functional structure of a search unit according to a third embodiment;

FIG. 7 is a flowchart illustrating a detailed flow of step S204 according to third and fourth embodiments;

FIG. 8 is a diagram illustrating an example of a functional structure of a search unit according to the fourth embodiment;

FIG. 9 is a diagram illustrating an example of a hardware structure of a computer used for the machine learning model compression system according to the first to fourth embodiments; and

FIG. 10 is a diagram illustrating an example of a device configuration of the machine learning model compression system according to the first to fourth embodiments.

### DETAILED DESCRIPTION

According to an embodiment, a machine learning model compression system includes a memory and a hardware processor. The hardware processor is coupled to the memory and configured to: analyze an eigenvalue of each layer of a machine learning model by using a data set and the machine learning model, the machine learning model having been learned based on the data set; determine a search range of a compressed model based on a count of eigenvalues, each of which is used for calculating a first value and causes the first value to exceed a predetermined threshold; select a parameter for determining a structure of the compressed model included in the search range; generate the compressed model by using the parameter, and judge whether the compressed model satisfies one or more predetermined restriction conditions or not.

Embodiments of a machine learning model compression system, a machine learning model compression method, and a computer program product will be described in detail below with reference to the accompanying drawings.

### First Embodiment

A machine learning model compression system according to the first embodiment will be described first.

Example of Functional Structure

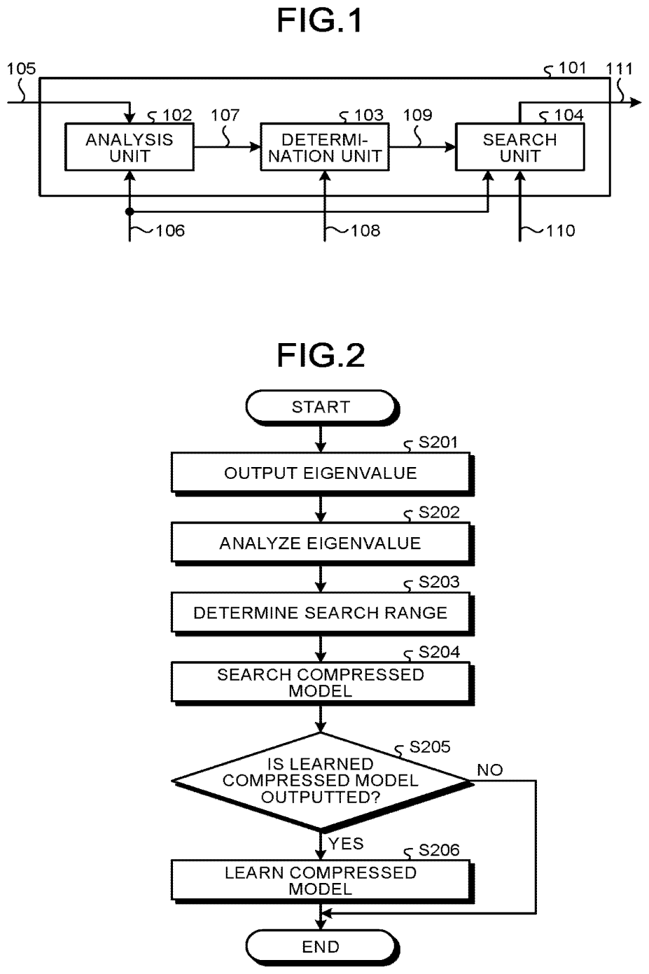

FIG. 1 is a diagram illustrating an example of a functional structure of a machine learning model compression system 101 according to the first embodiment. The machine learning model compression system 101 according to the first embodiment includes an analysis unit 102, a determination unit 103, and a search unit 104.

The analysis unit 102 receives a learned machine learning model 105 and a data set 106 used for learning the machine learning model 105. The analysis unit 102 analyzes an eigenvalue 107 for each layer of the machine learning model 105 by using the data set 106 and the machine learning model 105 learned based on the data set 106. More specifically, the analysis unit 102 analyzes a gram matrix per layer obtained as a result of reasoning (forward propagation) of the machine learning model 105 and outputs the eigenvalue 107 of the gram matrix.

The determination unit 103 determines a search range 109 of a compressed model based on a count of eigenvalues 107, each of which is used for calculating a value (a first value) and causes the first value to exceed a predetermined threshold.

An example of a method for calculating the count of the eigenvalues 107 will be specifically described. For example, the determination unit 103 sorts the eigenvalues 107 in a descending order, calculates a value (second value) obtained by sequentially adding the sorted eigenvalues 107, and calculates, as the first value for each layer, a cumulative contribution rate indicating a ratio of the second value to a total sum of all the eigenvalues. The determination unit 103 counts eigenvalues 107, each causing the cumulative contribution calculated as the first value to exceed a predetermined threshold (Th1).

Alternatively, for example, the determination unit 103 calculates, as the first value for each layer, a ratio of the eigenvalues 107 to the eigenvalue 107 of a maximum value (maximum eigenvalue). The determination unit 103 calculates counts eigenvalues 107, each causing the calculated ratio as the first value to exceed a predetermined threshold (Th2).

The foregoing predetermined threshold may be input to the determination unit 103 as, for example, search range determination assist information 108 for assisting determination of the search range. Alternatively, for example, the predetermined threshold may be held in advance as a default value in the machine learning model compression system 101.

The search unit 104 selects a parameter (e.g., hyperparameter) for determining a structure of a compressed model 111 included in the search range 109, and generates the compressed model 111 by using the parameter. The search unit 104 searches for the compressed model 111, which satisfies predetermined restriction conditions 110.

The predetermined restriction conditions 110 represent a set of restrictions that need to be satisfied when the compressed model 111 is operated in a target device. The predetermined restriction conditions 110 include, for example, an upper limit of a reasoning speed (processing time), an upper limit of a memory usage, and a binary size of the compressed model 111. Furthermore, for example, the predetermined restriction conditions 110 include a restriction condition on an evaluation value of the compressed model 111. The evaluation value is, for example, a value indicating recognition performance of the compressed model 111.

The search unit 104 repeats selecting the parameter, learning the compressed model 111, and calculating the evaluation value of the compressed model 111 until the predetermined end condition is satisfied.

Example of Machine Learning Model Compression Method

FIG. 2 is a flowchart illustrating an example of a machine learning model compression method according to the first embodiment.

First, the analysis unit 102 outputs the eigenvalues 107 of a gram matrix of each layer obtained as a result of reasoning (forward propagation) of the machine learning model 105 by using the data set 106 and the machine learning model 105 that has been learned based on the data set 106 (step S201).

Next, upon receiving the eigenvalue 107 output by the processing in step S201 and the search range determination assist information 108, the determination unit 103 outputs the search range 109 of the compressed model 111. More specifically, the determination unit 103 calculates an addition count Cnt of the eigenvalues 107 analyzed for each layer at a time point when the above cumulative contribution rate exceeds the predetermined threshold (Th1) (step S202). The Cnt is a count of nodes (a count of channels in a case of Convolutional Neural Network (CNN)) of each layer that is fundamentally necessary for the data set 106. Furthermore, in a case of processing in step S202, the search range determination assist information 108 is the predetermined threshold (Th1).

Alternatively, in step S202, the ratio of the eigenvalue 107 to the maximum eigenvalue may be calculated for each layer, and Cnt may be set to a count of eigenvalue 107, each causing the ratio of the eigenvalue 107 to the maximum eigenvalue to exceed the predetermined threshold (Th2)

Next, the determination unit 103 determines the search range 109 of the compressed model 111 based on the number Cnt of the eigenvalues 107, each causing the cumulative contribution rate calculated by processing in step S203 to exceed the predetermined threshold (Th1) (step S203). More specifically, the determination unit 103 sets Cnt to the upper limit of the count of nodes (or the count of channels) used when the compressed model 111 is searched for, and outputs the Cnt as the search range 109. By limiting the compressed model 111 to be searched for to the search range 109, it is possible to reduce a search time. In addition, by limiting the count of nodes (or the count of channels) to be searched for to, for example, a power of two, the search time may be further reduced.

Upon receiving the data set 106, the search range 109 determined by the processing in step S203, and the above predetermined restriction conditions 110, the search unit 104 searches for the compressed model 111 that satisfies the predetermined restriction conditions 110 within the search range 109 (S204).

In a case of outputting the learned compressed model 111 (step S205, Yes), the search unit 104 sufficiently learns the compressed model 111 searched for by the processing in step S204 by using the data set 106 (step S206), and outputs it as the learned compressed model 111.

The compressed model 111 output from the search unit 104 may be an unlearned compressed model (step S205, No). Information output from the search unit 104 may be, for example, a hyperparameter including information of the count of nodes (or the count of channels) of the compressed model 111. Furthermore, for example, the information output from the search unit 104 may be a combination of two or more of the unlearned compressed model 111, the learned compressed model 111, and the hyperparameter.

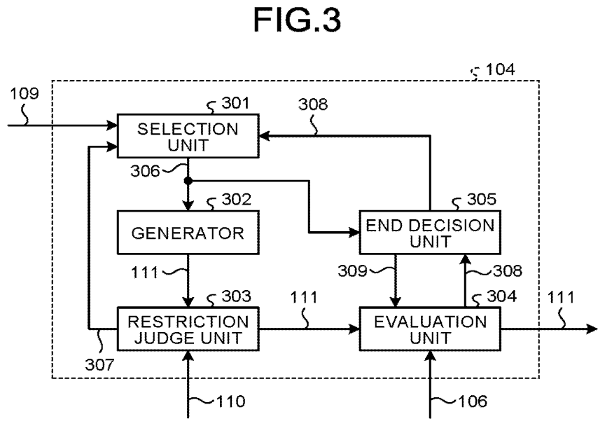

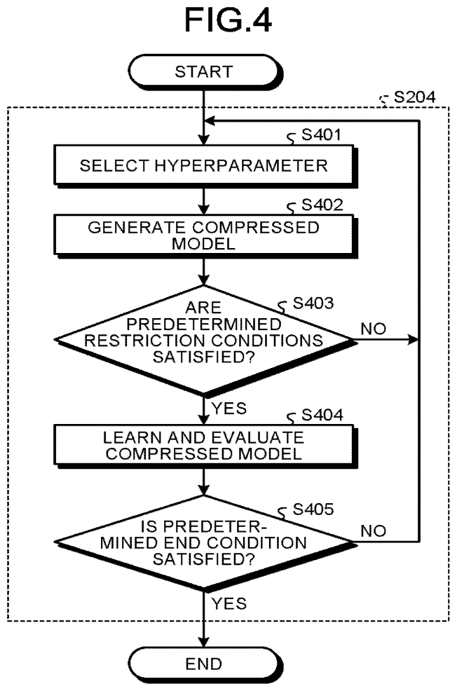

Next, a detailed operation method of the above search unit 104 will be described with reference to FIGS. 3 and 4.

FIG. 3 is a diagram illustrating an example of the functional structure of the search unit 104 according to the first embodiment. FIG. 4 is a flowchart illustrating a detailed flow of step S204 according to the first embodiment.

The search unit 104 according to the first embodiment includes a selection unit 301, a generator 302, a restriction judge unit 303, an evaluation unit 304, and an end decision unit 305.

The selection unit 301 selects a hyperparameter 306 including the information of the count of nodes (or the count of channels) as a parameter for determining a structure of the compressed model 111 included in the search range 109, and outputs the hyperparameter 306 (step S401).

Note that the method of selecting the compressed model 111 (the hyperparameter 306 for determining a model structure of the compressed model 111) may be optional. For example, the selection unit 301 may select, by using a Bayesian inference or a genetic algorithm, the compressed model 111 whose recognition performance will be enhanced. Furthermore, for example, the selection unit 301 may select the compressed model 111 by using random search or grid search. Furthermore, for example, the selection unit 301 may combine a plurality of selection methods, and select the more optimal compressed model 111.

The generator 302 generates the compressed model 111 indicated by the hyperparameter 306 selected in step S401, and outputs the compressed model 111 (step S402).

The restriction judge unit 303 decides whether the compressed model 111 generated by processing in step S402 satisfies the predetermined restriction conditions 110 (step S403).

When the predetermined restriction conditions 110 are not satisfied (step S403, No), the restriction judge unit 303 inputs, to the selection unit 301, a restriction dissatisfaction flag 307 indicating that the predetermined restriction conditions 110 are not satisfied. Then, processing is returned to step S401. When the predetermined restriction conditions 110 are not satisfied, processing in step S404 described below is not performed, so that it is possible to increase the speed of search of the compressed model 111. Upon receiving the restriction dissatisfaction flag 307 from the restriction judge unit 303, the selection unit 301 selects the hyperparameter 306 for determining the model structure of the compressed model 111 to be processed next (step S401).

On the other hand, when the predetermined restriction conditions 110 are satisfied (step S403, Yes), the restriction judge unit 303 inputs, to the evaluation unit 304, the compressed model 111 generated by processing in step S402.

Subsequently, the evaluation unit 304 learns the compressed model 111 for a predetermined period by using the data set 106, measures recognition performance of the compressed model 111, and outputs a value indicating the recognition performance as an evaluation value 308 (step S404).

For reducing the search time, a learning period during the processing in step S404 is set shorter than, for example, a learning period during the processing in above step S206 (see FIG. 2). Furthermore, in view of a learning situation of the compressed model 111, the evaluation unit 304 may terminate the learning when it decides that high recognition performance cannot be obtained. More specifically, the evaluation unit 304 may evaluate, for example, an increase rate of a recognition rate corresponding to the learning time, and terminate learning when the increase rate is the threshold or less. Consequently, it is possible to make search of the compressed model 111 efficient.

The end decision unit 305 decides an end of the search based on a predetermined end condition set in advance (step S405). The predetermined end condition is satisfied when, for example, the evaluation value 308 exceeds an evaluation threshold. Alternatively, the predetermined end condition may be satisfied when the number of times of evaluation (the number of times of evaluating the evaluation value 308) of the evaluation unit 304 exceeds a threshold number of times. Furthermore, for example, the predetermined end condition may be satisfied when the search time of the compressed model 111 exceeds a time threshold. Furthermore, for example, the predetermined end condition may be a combination of multiple end conditions.

The end decision unit 305 holds necessary information, such as the hyperparameter 306, the evaluation value 308 corresponding to the hyperparameter 306, the number of times of loop and a search elapsed time, in accordance with the end condition set in advance.

When the predetermined end condition is not satisfied (step S405, No), the end decision unit 305 inputs the evaluation value 308 to the selection unit 301. Then, processing is returned to step S401. Upon receiving the above evaluation value 308 from the end decision unit 305, the selection unit 301 selects the hyperparameter 306 for determining the model structure of the compressed model 111 to be processed next (step S401).

On the other hand, when the predetermined end condition is satisfied (step S405, Yes), the end decision unit 305 inputs, for example, the hyperparameter 306 of the compressed model 111 of the highest evaluation value 308 as a selected model parameter 309 to the evaluation unit 304. Upon receiving the selected model parameter 309, the evaluation unit 304 continues the processing from above step S205 (see FIG. 2).

As described above, in the machine learning model compression system 101 according to the first embodiment, the analysis unit 102 analyzes the eigenvalue 107 for each layer of the machine learning model 105 by using the data set 106 and the machine learning model 105 learned based on the data set 106. The determination unit 103 determines the search range 109 of the compressed model 111 based on a count of the eigenvalues 107, each of which is used for calculating a value (a first value) and causes the first value to exceed a predetermined threshold. Furthermore, the search unit 104 selects the parameter for determining the structure of the compressed model 111 within the search range 109, generates the compressed model 111 by using the parameter, and judges whether the compressed model 111 satisfies the predetermined restriction conditions 110 or not.

Consequently, according to the first embodiment, it is possible to efficiently compress the machine learning model 105 under the predetermined restriction conditions. For example, while keeping a balance between a restriction such as a processing time and a memory usage, and recognition accuracy, it is possible to efficiently compress the machine learning model 105.

More specifically, by, for example, analyzing the eigenvalue 107 of the gram matrix of the learned machine learning model 105, it is possible to estimate the count of nodes (or the count of channels) which is fundamentally necessary to recognize the target data set 106, and determine the search range 109 of the machine learning model 105. Therefore, it is possible to search for, for example, the compressed model 111 that can maximize the recognition accuracy under the predetermined restriction conditions 110.

Furthermore, according to the first embodiment, even a user who does not have a professional knowledge and experience about machine learning can set the appropriate search range 109, and efficiently search for the compressed model 111 that operates in a powerless edge device such as an in-vehicle image recognition processor, a mobile terminal or a MultiFunction Printer (MFP).

### Second Embodiment

Next, the second embodiment will be described. In the second embodiment, the same description as that of the first embodiment is omitted. The second embodiment differs from the first embodiment in that, not an end decision unit 305 but a selection unit 301 performs the decision of an end.

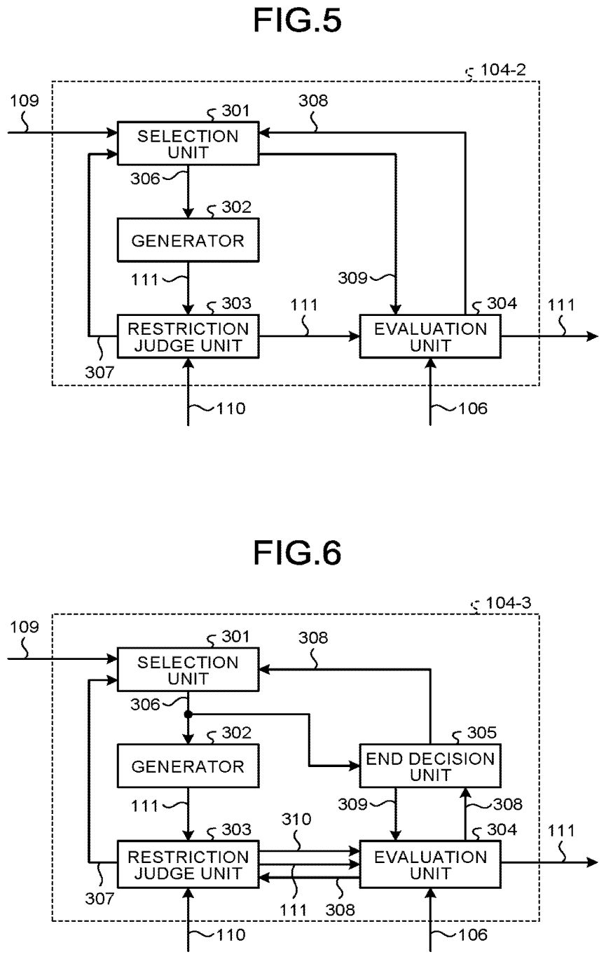

FIG. 5 is a diagram illustrating an example of the functional structure of a search unit 104-2 according to the second embodiment. The search unit 104-2 according to the second embodiment includes the selection unit 301, a generator 302, a restriction judge unit 303, and an evaluation unit 304.

Information used to decide the end is held by the selection unit 301 in accordance with a predetermined end condition that is set in advance. Upon receiving an evaluation value 308 from the evaluation unit 304, the selection unit 301 decides the end. When the predetermined end condition is not satisfied, the selection unit 301 selects a hyperparameter 306 for determining a model structure of a compressed model 111 to be processed next. When the end condition is satisfied, the selection unit 301 inputs to the evaluation unit 304, for example, the hyperparameter 306 of the compressed model 111 whose evaluation value 308 is the highest as a selected model parameter 309. Upon receiving the selected model parameter 309, the evaluation unit 304 continues the processing from above step S205 (see FIG. 2).

As described above, according to the second embodiment, by providing a function of the end decision unit 305 to the selection unit 301, it is possible to obtain the same effect as that of the first embodiment even when the end decision unit 305 is not provided.

### Third Embodiment

Next, the third embodiment will be described. In the third embodiment, the same description as that of the first embodiment is omitted. The third embodiment will describe a case where a lower limit of recognition performance of a compressed model 111 is set as predetermined restriction conditions 110.

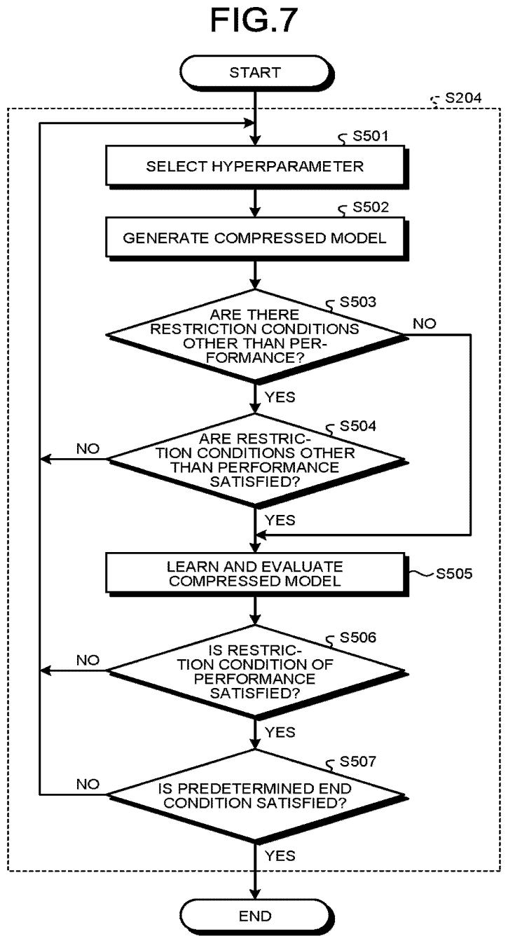

FIG. 6 is a diagram illustrating an example of the functional structure of a search unit 104-3 according to the third embodiment. FIG. 7 is a flowchart illustrating a detailed flow of step S204 according to the third embodiment.

The search unit 104-3 according to the third embodiment includes a selection unit 301, a generator 302, a restriction judge unit 303, an evaluation unit 304, and an end decision unit 305.

Explanation of steps S501 and S502 is omitted since these steps are the same as the foregoing steps S401 and S402.

The restriction judge unit 303 determines whether restriction conditions other than performance are included in the predetermined restriction conditions 110 (step S503). The restriction conditions other than the performance are, for example, a binary size of the compressed model 111, a memory usage, and a reasoning speed (a processing time required for reasoning). The restriction condition on the performance is, for example, a lower limit of a value (e.g., a recognition rate of image recognition) indicating recognition performance.

For deciding whether requested performance is satisfied, a time is required since the compressed model 111 needs to be learned for a sufficient period equivalent to that in step S206 (see FIG. 2). Hence, among restriction conditions in the predetermined restriction conditions 110, the restriction judge unit 303 firstly decides whether restriction conditions other than the performance are satisfied.

When the restriction conditions other than the performance are found (step S503, Yes), the restriction judge unit 303 decides whether the restriction conditions other than the performance are satisfied (step S504).

When the restriction conditions other than the performance are not satisfied (step S504, No), the restriction judge unit 303 inputs the restriction dissatisfaction flag 307 to the selection unit 301. Then, processing is returned to step S501.

When the restriction conditions other than the performance are satisfied (step S504, Yes), the restriction judge unit 303 inputs the compressed model 111 to the evaluation unit 304. The evaluation unit 304 learns the compressed model 111 for a predetermined period by using a data set 106, measures recognition performance of the compressed model 111, and outputs a value indicating the recognition performance as an evaluation value 308 (step S505).

Subsequently, the evaluation unit 304 inputs the evaluation value 308 to the restriction judge unit 303. The restriction judge unit 303 decides whether the recognition performance satisfies the predetermined restriction conditions 110 (step S506).

When the recognition performance does not satisfy the predetermined restriction conditions 110 (step S506, No), the restriction judge unit 303 inputs the restriction dissatisfaction flag 307 to the selection unit 301. Then, processing is returned to step S501.

When the recognition performance satisfies the predetermined restriction conditions 110 (step S506, Yes), the restriction judge unit 303 inputs, to the evaluation unit 304, a restriction satisfaction flag 310 indicating that the compressed model 111 satisfies the predetermined restriction conditions 110. Upon receiving the restriction satisfaction flag 310 from the restriction judge unit 303, the evaluation unit 304 inputs the evaluation value 308 to the end decision unit 305.

Explanation of Step S507 is omitted since this step is the same as the foregoing step S405.

As described above, according to the third embodiment, the restriction judge unit 303 firstly decides whether the restriction conditions other than the performance is satisfied, among the restriction conditions included in the predetermined restriction conditions 110. When the restriction conditions other than the performance are not satisfied, the selection unit 301 newly selects a hyperparameter 306 for determining the model structure of the compressed model 111 to be processed next. Therefore, according to the third embodiment, it is possible to further increase a speed of searching for the compressed model 111.

### Fourth Embodiment

Next, the fourth embodiment will be described. In the fourth embodiment, the same description as that of the third embodiment is omitted. The fourth embodiment differs from the third embodiment in that, not an end decision unit 305 but a selection unit 301 performs the decision of an end.

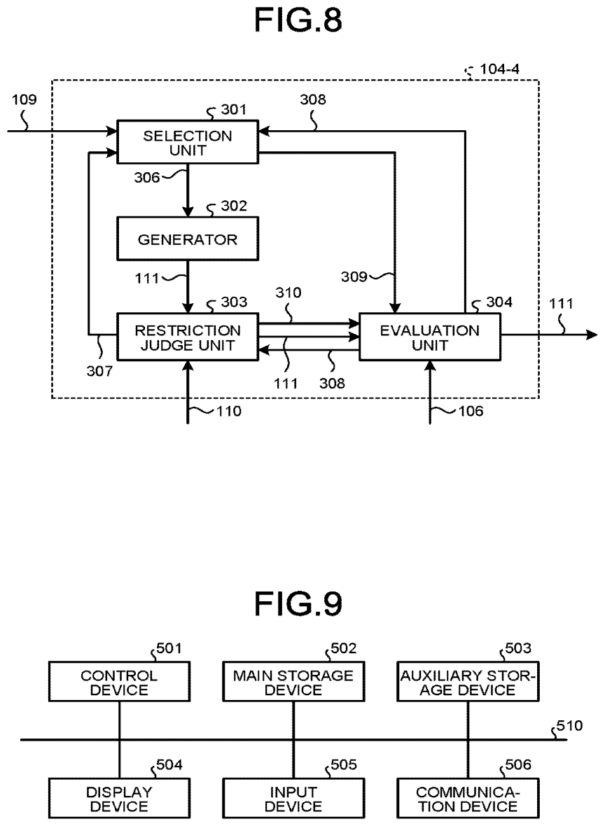

FIG. 8 is a diagram illustrating an example of the functional structure of a search unit 104-4 according to the fourth embodiment. The search unit 104-4 according to the fourth embodiment includes the selection unit 301, a generator 302, a restriction judge unit 303, and an evaluation unit 304.

Information used to decide the end is held by the selection unit 301 in accordance with a predetermined end condition that is set in advance. Upon receiving a restriction satisfaction flag 310 from the restriction judge unit 303, the evaluation unit 304 inputs an evaluation value 308 to the selection unit 301. Upon receiving the evaluation value 308 from the evaluation unit 304, the selection unit 301 decides the end. When the predetermined end condition is not satisfied, the selection unit 301 selects a hyperparameter 306 for determining a model structure of a compressed model 111 to be processed next. When the predetermined end condition is satisfied, the selection unit 301 inputs, as a selected model parameter 309 to the evaluation unit 304, for example, the hyperparameter 306 of the compressed model 111 whose evaluation value 308 is the highest. Upon receiving the selected model parameter 309, the evaluation unit 304 continues the processing from above step S205 (see FIG. 2).

As described above, according to the fourth embodiment, by providing a function of the end decision unit 305 to the selection unit 301, it is possible to obtain the same effect as that of the third embodiment even when the end decision unit 305 is not provided.

Lastly, an example of a hardware structure of a computer used for a machine learning model compression system 101 according to the first to fourth embodiments will be described.

Example of Hardware Structure

FIG. 9 is a diagram illustrating an example of a hardware structure of a computer used for the machine learning model compression system 101 according to the first to fourth embodiments.

The computer used for the machine learning model compression system 101 includes a control device 501, a main storage device 502, an auxiliary storage device 503, a display device 504, an input device 505, and a communication device 506. The control device 501, the main storage device 502, the auxiliary storage device 503, the display device 504, the input device 505, and the communication device 506 are connected via a bus 510.

The control device 501 executes a program read from the auxiliary storage device 503 to the main storage device 502. The main storage device 502 is a memory such as a Read Only Memory (ROM) or a Random Access Memory (RAM). The auxiliary storage device 503 is, for example, a Hard Disk Drive (HDD), a solid State Drive (SSD), or a memory card.

The display device 504 displays information to be displayed. The display device 504 is, for example, a liquid crystal display. The input device 505 is an interface for operating the computer. The input device 505 is, for example, a keyboard or a mouse. When the computer is a smart device such as a smartphone or a tablet terminal, the display device 504 and the input device 505 are implemented by, for example, a touch panel mechanism. The communication device 506 is an interface for communicating with another device.

A program executed by the computer is recorded in an installable format or an executable format on a computer-readable storage medium, such as a CD-ROM, a memory card, a CD-R, or a Digital Versatile Disc (DVD), to be provided as a computer program.

The program executed by the computer may be provided such that, the program is installed in the computer connected with a network such as the Internet, and is downloaded via the network. Alternatively, the program executed by the computer may be provided via the network such as the Internet without downloading.

Furthermore, the program executed by the computer may be provided by storing in advance in the ROM.

The program executed by the computer may employ a module configuration including functional blocks which can be realized by the program among functional structures (functional blocks) of the above machine learning model compression system 101. Each functional block is executed when the control device 501, which is actual hardware, reads out the program from the storage medium and executes the program, and then each of the above functional blocks is loaded onto the main storage device 502. That is, each of the above functional blocks is generated on the main storage device 502.

In addition, part of or all the functional blocks may be realized by hardware, such as an Integrated Circuit (IC), without being realized by software.

Furthermore, when each function is realized by using processors, each processor may realize one of each function, or may realize two or more of the functions.

Furthermore, an operation style of the computer, which realizes the machine learning model compression system 101, may be optional. For example, the machine learning model compression system 101 may be realized by one computer. Furthermore, the machine learning model compression system 101 may be operated as a cloud system on the network.

Example of Device Configuration

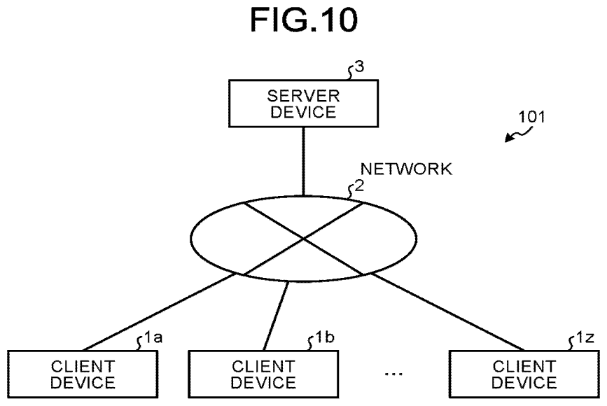

FIG. 10 is a diagram illustrating an example of a device configuration of the machine learning model compression system 101 according to the first to fourth embodiments. In the example in FIG. 10, the machine learning model compression system 101 includes client devices 1a to 1z, a network 2, and a server device 3.

In a case where there is no need to distinguish the client devices 1a to 1z, the client devices 1a to 1z will be simply referred to as a client device 1. The number of the client devices 1 in the machine learning model compression system 101 may be optional. The client device 1 may be a computer such as a personal computer or a smartphone. The client devices 1a to 1z and the server device 3 are connected with each other via the network 2. A communication scheme of the network 2 may be a wired scheme, a wireless scheme, or a combination of the both.

For example, an analysis unit 102, a determination unit 103, and a search unit 104 of the machine learning model compression system 101 may be implemented by the server device 3, and be operated as a cloud system on the network 2. Specifically, the client device 1 may receive a machine learning model 105 and a data set 106 from a user, and transmit the machine learning model 105 and the data set 106 to the server device 3. In this case, the server device 3 may transmit to the client device 1 the compressed model 111 searched for by the search unit 104.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning model compression system comprising:
a memory; and
a hardware processor coupled to the memory and configured to
analyze eigenvalues of each layer of a machine learning model by using a data set and the machine learning model, the machine learning model having been learned based on the data set,
determine a search range of a compressed model based on a count of eigenvalues, each of which is used for calculating a first value and causes the first value to exceed a predetermined threshold,
select a parameter for determining a structure of the compressed model included in the search range,
generate the compressed model by using the parameter, and
judge whether the compressed model satisfies one or more predetermined restriction conditions or not.

2. The system according to claim 1, wherein
the one or more predetermined restriction conditions include one or more restriction conditions on an evaluation value of the compressed model, and
the hardware processor is configured to repeat selecting the parameter, learning the compressed model, and calculating the evaluation value of the compressed model until one or more predetermined end conditions are satisfied.

3. The system according to claim 1, wherein the hardware processor is configured to
sort the eigenvalues in a descending order,
calculate a second value by sequentially adding the sorted eigenvalues,
calculate, as the first value for each layer, a cumulative contribution rate indicating a ratio of the second value to a total sum of all the eigenvalues, and
count eigenvalues, each causing the cumulative contribution calculated as the first value to exceed a predetermined threshold.

4. The system according to claim 1, wherein the hardware processor is configured to
calculate, as the first value for each layer, ratios of the eigenvalues to a maximum eigenvalue, and
count eigenvalues, each causing the calculated ratio as the first value to exceed a predetermined threshold.

5. The system according to claim 1, wherein the predetermined threshold is input to the hardware processor as search range determination assist information for assisting the determination of the search range.

6. The system according to claim 1, wherein the hardware processor is configured to determine the search range by setting the count of the eigenvalues, which exceeds the predetermined threshold, as an upper limit of the search range.

7. The system according to claim 2, wherein
the predetermined restriction conditions include one or more restriction conditions on performance of the compressed model and one or more restriction conditions other than the performance of the compressed model, and
the hardware processor is configured to
decide whether the one or more restriction conditions other than the performance of the compressed model is satisfied, prior to whether the one or more restriction conditions on the performance of the compressed model is satisfied, and
select a new parameter when the one or more restriction conditions other than the performance of the compressed model is not satisfied.

8. The system according to claim 2, wherein the predetermined end condition is satisfied when the evaluation value exceeds an evaluation threshold, when a number of times of evaluating the evaluation value exceeds a threshold number of times, or when a search time of the compressed model exceeds a time threshold.

9. The system according to claim 2, wherein the evaluation value is a value indicating recognition performance of the compressed model.

10. A machine learning model compression method implemented by a computer, the method comprising:
analyzing eigenvalues of each layer of a machine learning model by using a data set and the machine learning model, the machine learning model having been learned based on the data set;
determining a search range of a compressed model based a count of eigenvalues, each of which is used for calculating a first value and causes the first value to exceed a predetermined threshold; and
selecting a parameter for determining a structure of the compressed model included in the search range;
generating the compressed model by using the parameter, and
judging whether the compressed model satisfies one or more predetermined restriction conditions or not.

11. A computer program product comprising a non-transitory computer-readable recording medium on which an executable program is recorded, the program instructing a computer to:
analyze eigenvalues of each layer of a machine learning model by using a data set and the machine learning model, the machine learning model having been learned based on the data set;
determine a search range of a compressed model based a count of eigenvalues, each of which is used for calculating a first value and causes the first value to exceed a predetermined threshold; and
select a parameter for determining a structure of the compressed model included in the search range;
generate the compressed model by using the parameter; and
judge whether the compressed model satisfies one or more predetermined restriction conditions or not.
